(19) United States
(12) Patent Application Publication
(10) Pub. No.: US 2009/0316054 A1
(43) Pub. Date: Dec. 24, 2009

(54) Characteristic Voice Dependent Recognition Wireless Universal Remote control Capabilities

(75) Inventor: Vikii Dream Bailey, Atlanta, GA (US)

Correspondence Address: Catherine Bailey, POB 7696, Atlanta, GA, 30309, US

(73) Assignees: Vikii Dream Bailey, Atlanta, GA (US); Catherine Boykins Bailey, Atlanta, GA (US)

(21) Appl. No.: 12/436,836

(22) Filed: May 7, 2009

Related U.S. Application Data
(63) Continuation-in-part of application No. 10/960,519, filed on Jun. 7, 2004, now abandoned.

(51) Int. Cl. G10L 15/00; G08C 19/12; H04N 5/44

(52) U.S. Cl. 348/734; 341/176; 704/246; 348/E05.096; 704/E15.001

(57) ABSTRACT

A Characteristic Voice Dependent Recognition Wireless Universal Remote Control Capabilities has a power management mode controller with an Alternative Satellite long range wireless cordless phone functionality that includes administer change of controls conditions between communication equipment and universal remote control equipment bridged between a base unit with Satellites server features are provided as part of or as an overlay in order to assist the user in control management wirelessly without key/buttons press, or LCD screen display unit and may emulate a wireless EPABX—electronic private automatic branch exchange. The universal remote control provides Characteristic mode controller functionality wherein an overlay is placed over a display device and can be any of a variety of different display devices, such as a cathode ray tube (CRT) television, plasma/flat panel television, liquid crystal display (LCD), projector, and so forth, and the universal remote control equipment for remote control of plurality remotely controlled electronics on screen overlay on screen display of communication entertainment equipment. An interactive Characteristic overlay is displayed on the full-screen display. Both program content and media Characteristic mode controller content are displayed on a full-screen display such as a television. An interactive Characteristic overlay is displayed, and this interactive Characteristic overlay is of voice dependent and can be displayed independent of any user request for the overlay to be displayed automatically upon set program during which reception of the direction mode indicator indicates that the mode controller selection command is made for the device. The notification icon can be selected by a user by biometric mechanism, or by automatic preprogramming mode controller to respond, and in response to such a selection the interactive Characteristic overlay is displayed to the user.

### CROSS REFERENCED TO RELATED APPLICATION

This application is a amendment to the Continuation In Part of parent application Ser. No. 10,960,519 filed Jun. 7, 2004 which is hereby incorporated by reference in its entry.

### BACKGROUND

1. Field of Invention

The present invention relates in general to power management of a wireless universal remote control of communication entertainment equipment and universal remote control for control of entertainment equipment. The present invention relates to a wireless base unit Satellites server that provides both Characteristics automatic communication entertainment control and caller ID view capabilities. ©2003 Vikii D. Bailey” (17 U.S.C. 401) and “Catherine B. Bailey” (17 U.S.C. 909)

The principles of the invention, as defined by the claims appended herein, can obviously be applied beyond the specifically described embodiments of the invention described herein. Moreover, in the description of the present invention, certain details have been left out in order to not obscure the inventive aspects of the invention. The details left out are within the knowledge of a person of ordinary skill in the art.

2. Description of Prior Art

This society has become dependent on convenience meaning you want to get up off the couch as little as possible for example short range cordless telephone is a part of this era they are easy to keep nearby for use in answering incoming calls. For instance if a person is to sit on a couch and watch television that person might place a short range cordless telephone within arms reach if a call comes in, the call could be answered without getting up from the couch. The universal remote control is another type of personal convenience item that has attained widespread acceptance and utilization. If a person was to sit on a couch to watch television in addition to placing the cordless phone nearby, one might also place the universal remote control nearby. In another instance wired DVD, VCR, SAT, DVR is an inconvenience for those who are not electronic user friendly. Patiently therefore, cordless telephone and universal remotes each provides certain benefits with regards to their respective field of application, the fields of personal and utilization of entertainment devices, respectively dissemination.

Therefore, today's universal remote control are typically limited to physical operation for example, if a person wants to change the channel on a television and reduce the volume on an entertainment device the user must locate the remote control and operate the device change or reduce volume button or key. However, as recognized by the present invention, physical operation is an incomfort to the user. A more convenience world would enjoy if the user had free control of certain entertainment devices. Moreover, a wireless characteristic automated voice independent remote communication entertainment equipment and universal remote control equipment would greatly improve convenience for the user. Since one of the primary objects of the universal remote control is to allow the user to do as little as possible. Any increase in convenience would be powerful. To allow the user to move about and do more hand involve duties and be able to automatically control any remotely control equipment with out the use of buttons, LCD screens or LCD touch screen icons would fit on the convenience level. The present invention recognizes that physical operation are inconvenience and universal remote controls could be substantially improved.

Commonly assigned U.S. patent application Ser. Nos. 10/288,727 entitled “User Interface for a Hand Held Universal Remote Control Device” and 10/410,103 entitled “Universal Remote Control with a Local Screen Guided Setup,” which published applications for patent are hereby incorporated by reference in their entirety. Further, U.S. Pat. No. 5,128,987 issued to McDonough, U.S. Pat. No. 5,542,102 issued to Smith et al. and Korean Patent number 9,07064 issued to Pope explains that the patent relates to a handset that includes an infrared transmitter for muting television. None of the above patents, however, contain any suggestion to provide a device that can be customized by the user to change the way automated responses are made to changing conditions, where the conditions may relate to an entertainment device (such as a DVR) or to many communication equipment (such as when a (IR) code is transmitted out or comes in) by way of a Characteristic mode controller, stand alone base unit.

### OBJECTS AND ADVANTAGES

The principles of the invention is an amendment to the Continuation in Part application referenced to the prior parent application Ser. No. 10,960,519 which reference to application Ser. No. 12,436,836 Continuation In Part (CIP) non provisional application as defined by the claims appended herein, can obviously be applied beyond the specifically described embodiments of the invention described herein. Moreover, in the description of the present invention, certain details have been left out in order to not obscure the inventive aspects of the invention. The details left out are within the knowledge of a person of ordinary skill in the art.

The Characteristic voice dependent recognition system power management of the Characteristic mode controller changes conditions within the communication equipment and the remote control equipment provides an on screen overlay, on screen display (OSD) wherein an overlay is placed over a display device and can be any of a variety of different display devices, such as a cathode ray tube (CRT) television, plasma/flat panel television, liquid crystal display (LCD), projector, and so forth, and the universal remote control equipment for remote control of plurality remotely controlled electronics on screen overlay on screen display of communication entertainment equipment. An interactive characteristic overlay is displayed on the full-screen display. Both program content and media Characteristic mode controller content are displayed on a full-screen display such as a television. An interactive Characteristic overlay is displayed, and this interactive characteristic overlay is of voice dependent and can be displayed independently of any user request for the overlay to be displayed automatically upon initial programming during which reception of the functionality control indicator indicates that the Characteristic mode controller selection command is made for a device. Power management command functionality operations of many appliances of various types and various manufacturers has no limitation in the present invention.

The present invention may include a mechanism, e.g., for secondary USER number two contactless control of one or more entertainment communication device without the use of keys, a scroll wheel, navigation keys, buttons, or the likes, for placing the universal remote controls Characteristic mode controller and base unit into an power management operating mode for transmitting commands that are appropriate for the one or more remotely entertainment communication control devices that have been assigned to or programmed for that operating mode. Further, may be placed into a mode wherein its functions as an Alternative wireless, contactless Satellites long range cordless telephone. Let it be also known that Characteristic Voice Dependent Recognition Wireless Universal Remote Control Capabilities is not of cellular telephone means.

The Characteristic voice operated remote control intended to replace multiple entertainment remotely communication control capabilities and has the functionality of all remote control functionality using motion detection and can be any type of motion detector that senses when the Characteristic mode controller is in need of a command change or when secondary USER number two must provide a response to a control command. A Characteristic Voice Dependent Recognition Wireless Universal Remote Control Capabilities in which an infrared (IR)(RF) signal is transmitted from a transmitting apparatus is received and reproduced as a recognizable code by a Characteristic mode controller unit portion, the mode controller is of Characteristic interactive on screen overlay which is displayed on the full-screen display, also can be an embedded internal communication entertainment equipment mode controller. Characteristic in this reference can mean with no limitation avatars and the likes. The Satellites server apparatus is a part of a computer system and includes having a Satellites server mailbox for storage of information capabilities. The base unit is the bridge to the Satellites server mailbox. Characteristic mode controller and the communication entertainment equipment can have many functionality with no limitation. No button press, LCD screen icon selection or key press is needed to operate the Characteristic mode controller. Mode controller is completely wireless, button less and keyless. During operation the base unit translates, receives and sends each electronic driver (IR)(RF) code signal to the Characteristic mode controller. This code signal is translated and transmitted to the Characteristic mode controller on screen display (OSD) wherein the OSD detects a command code and a residual (tenant) is used to detect spoken commands if there is any from USER number one. In response to any commands, learned (IR) code commands are transmitted by the mode controller to the devices simultaneously directing them toward the appropriate entertainment system and carrying out the function. Further, Characteristic Voice Dependent Recognition Wireless Universal Remote Control Capabilities consisting of;

1. A Satellites server computer system having information storage capabilities.

2. A wireless Characteristic mode controller charging terminals.

3. An apposition and balance point, interpolated microphone, transducer configured within the Characteristic mode controller.

4. The Characteristic mode controller is wireless and is motion detecting using biometric mechanisms.

5. The Characteristic mode controller is of Satellites capability with the use of (OSD) on screen display.

6. The base unit is a wireless bridge to the Satellites server and Characteristic mode controller.

7. The wireless base unit has a transducer and is standalone capable.

A second aspect of the present invention in a wireless base unit having a charging terminals for charging a Characteristic mode controller, secondary battery included and preferably uses little power and relays a microphone signal that represents speech among other noise. The Characteristic mode controller is programmed to receive and automatically transmit preset programmed code signals. The base unit is either in line with infrared code signal, or is programmed to receive and automatically transmit preset programmed code signals. The base unit translates the spoken commands code thereby produces a residual (tenant) used to recognize the Characteristic mode controller spoken commands, USER number one is the Characteristic mode controller and secondary USER number two is the initial client. Upon detect of a spoken command by USER number one, infrared codes commands can then be translated by the base unit then transmitted to the Characteristic mode controller as an infrared code command and also have an infrared repeater for relaying commands back to the appropriate communication entertainment equipment. Also, upon detect of a Characteristic mode controller on screen display infrared codes commands can also be transmitted to the communication entertainment equipment wirelessly. The mentioned five convenience modes are known as automated with no limitation to the number of convenience modes to be used. All convenience modes are controlled by the Characteristic mode controller, and base unit. The user of communication entertainment equipment is automatically and dynamically allowed utilization of embedded communication entertainment equipment wirelessly, or wired entertainment equipments with no limitation but at least one DVR, DVD, VCR, SAT, and the likes to be provided as an alternative to wired entertainment equipment. A Satellites server will transmit the requested entertainment material to the base unit and Characteristic mode controller by way of Satellites server computer system. All objects features and advantages of the present invention will become apparent in the following detailed written description.

### BRIEF DESCRIPTION OF DRAWING FIGURES

FIG. 1. Shows a perspective view illustrating versatility of Characteristic mode controller use according to the present invention.

FIG. 2. Shows an illustrating perspective view illustrating the base unit of a Characteristic Voice Dependent Recognition Wireless Universal Remote Control Capabilities.

FIG. 3. Illustrates the backside movement of the Characteristic mode controller and also relates to directional swivel signal pickup, mode controller swivel unit for adjustability positioning, body which includes a stand alone voice recognition circuitry, microphone, and swivel mode controller unit.

FIG. 4. Illustrates microphone positioning from the front side view, body, Characteristic mode controller directional swivel unit is outlined.

FIG. 5. Illustrates the circuitry of the Characteristic mode controller unit, for receiving light receiving signals from the back end of unit, three LED units, speaker line, body, and microphone

FIG. 6. Illustrates the charging mode of the base unit, body, three LED units, outline Characteristic mode controller in charging mode, mode controller unit, body, and microphone;

FIG. 7. Illustrates to view of Characteristic mode controller unit, directional swivel signal pickup unit and microphone.

### REFERENCE NUMERALS IN DRAWINGS

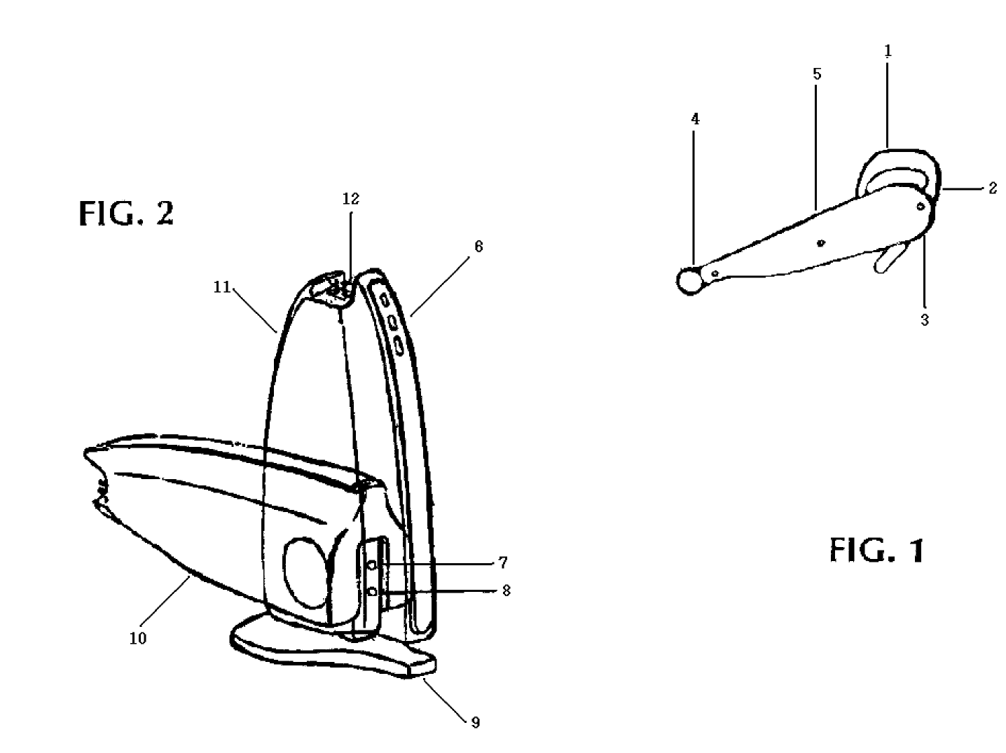

FIG. 1.

1. Directional signal pickup engagement

2. Characteristic Mode controller unit portion

3. Swivel supporter

4. Microphone

5. Body

FIG. 2.

6. (RF) (IR) receiving portion

7. Train button

8. Program button

9. Base (stand)

10. 11. Body

12. Armpit charger portion

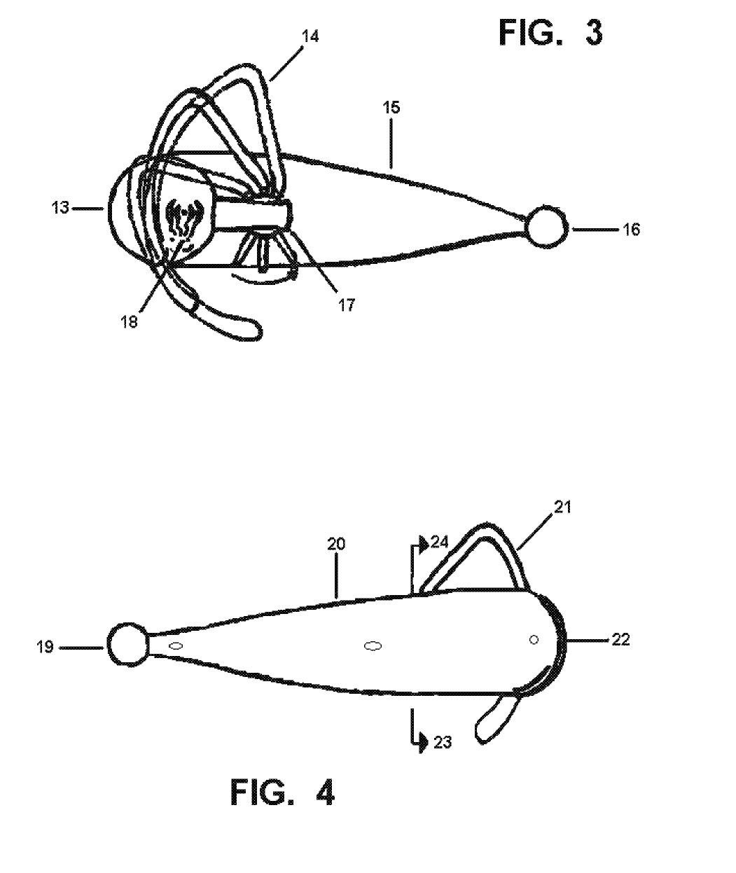

FIG. 3.

13. Speaker/battery portion

14. Directional swivel signal pickup engagement

15. Body

16. Microphone

17. Swivel support unit

18. Speaker

FIG. 4.

19. Microphone

20. Body

21. Directional swivel signal pickup engagement

22. Characteristic Mode Controller unit portion

23. 24. Swivel supporter

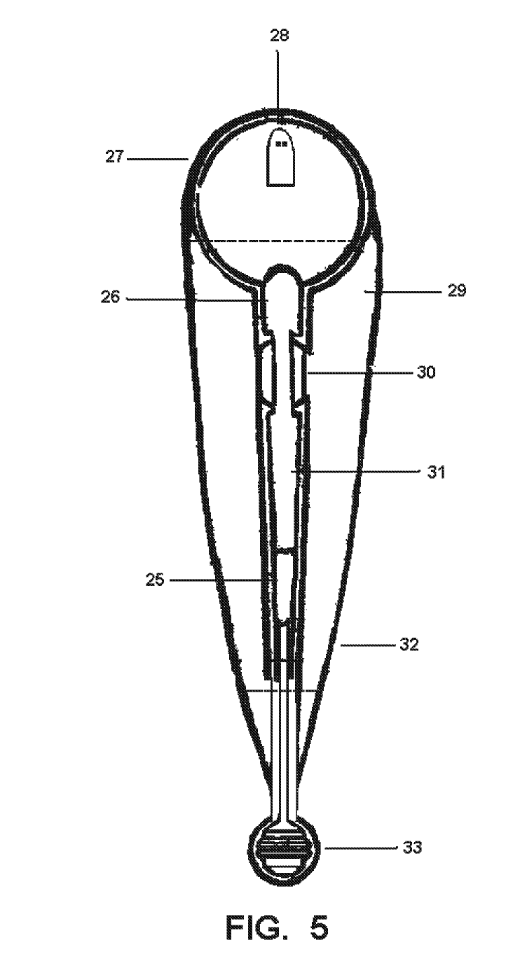

FIG. 5.

25. LED 1 lower end

26. LED 2 middle

27. Characteristic Mode Controller unit/battery/speaker

28. LED 3 top end

29. Circuit board

30. LED enclosure tube

31. LED connector

32. Body

33. Microphone

FIG. 6.

34. Body

35. LED 1,2,3

36. Characteristic Mode Controller charger armpit

37. Directional Swivel engagement

38. Body

39. Microphone

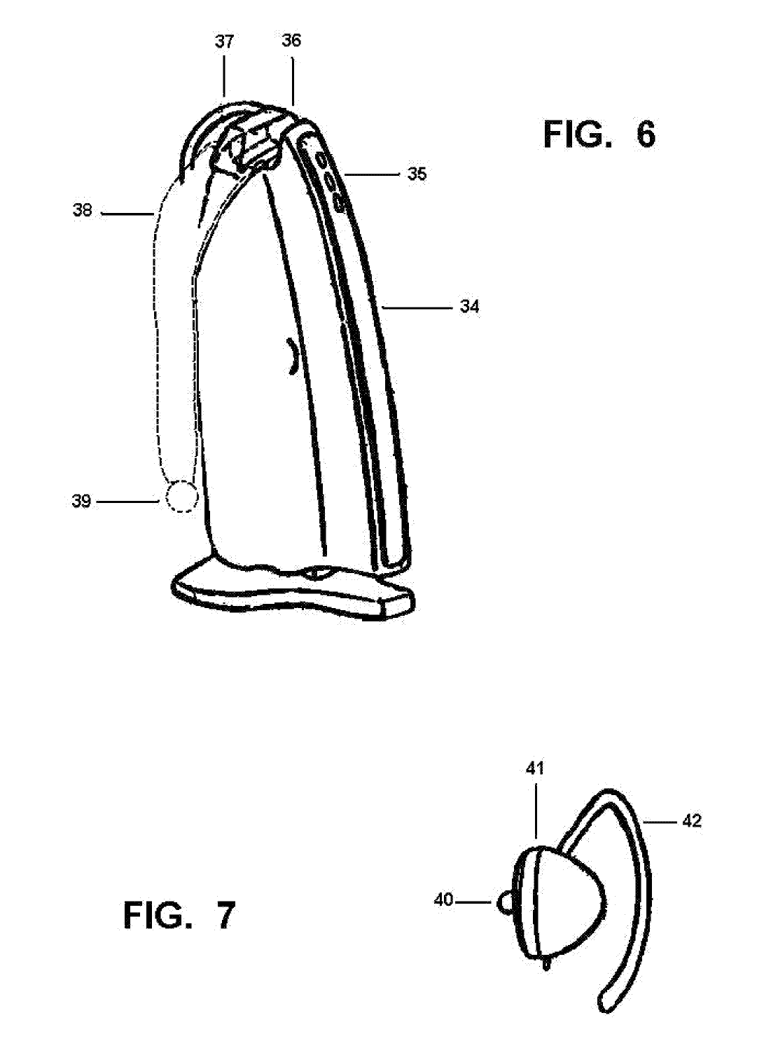

FIG. 7.

40. microphone

41. Body

42. Characteristic Mode Controller directional swivel signal pickup engagement

### DETAILED DESCRIPTION

The present invention is an amendment to the continuation in part application referenced to the prior parent application Ser. No. 10,960,519 which cross reference to application Ser. No. 12,436,836 Continuation In Part (CIP) filed on Jun. 7, 2004.

FIG. 1. a Characteristic Voice Dependent Recognition Wireless Universal Remote Control Capabilities according to an embodiment of the present invention, a secondary communication transmitter labeled the USER number two can transmits infrared light (IR) (RF) signals to the base unit then transmit and reproduce a responding signal to the Characteristic mode controller by way of biometric mechanism. So if the command is to be heard, it will be heard by the base unit by way of the Characteristic mode controller and is powered by a secondary battery, (not shown) a rechargeable battery which may be recharged by a charging operation as will be described herein after.

The detailed description in the preferred specific implementation of a Characteristic Voice Dependent Recognition Wireless Universal Remote Control Capabilities wherein the two different components serves both as change of condition control communication equipment and Universal remote control equipment. The universal remote control provides Characteristic mode controller functionality wherein an overlay is placed over a display device and can be of a variety of different display devices, such as a cathode ray tube (CRT) television, plasma/flat panel television, liquid crystal display (LCD), projector, and so forth. The universal remote control equipment for remote control of plurality remotely controlled electronics is by way of on screen overlay on screen display. An interactive Characteristic overlay is displayed on the full-screen display. Both program content and media Characteristic mode controller content are displayed on a full-screen display such as a television, this interactive characteristic overlay is of voice dependent and can be displayed independent of any user request for the overlay to be displayed or automatically upon initial programming during which reception of the direction motion detector indicator indicates that the Characteristic mode controller selection command is made for a device. Additionally, an notification icon can be displayed during display of the program content and/or the media content or callers ID view. The notification icon can be selected by a secondary USER number two by biometric mechanism, or by automatic preprogramming Characteristic mode controller to respond, and in response to such a selection the interactive characteristic overlay is displayed to the user.

However, the communication equipment and Universal remote control includes a component that appears neither in remote controls nor in universal remote controls that component is the Characteristic mode controller with no limitation to the many functionalities such as Alternative long range Satellites wireless cordless phone functionality. Mode controller is not part of the communication equipment nor the Universal remote control. Instead, Characteristic mode controller is a stand alone wireless programmable bridge that functionally connects base unit, communication equipment by wirelessly allowing power management changing conditions as a traditional universal remote control would with buttons, keys or LCD screen press in such a way as to provide for enhanced user convenience. Characteristic Mode controller has no limitation and may be considered or referred to as USER number one. A Characteristic Voice Dependent Recognition Wireless Universal Remote Control Capabilities is without buttons, LCD touch screen, keys, or LCD touch screen with icons press and is a stand alone unit. The Characteristic mode controller will have “Accessories” which can be embedded internally into the communication entertainment equipment or stand alone as a mode controller with no limitation and may be considered as control contactless. The primary functions of the preferred base unit are to capture a good voice signal from the Characteristic mode controller on screen display, and also relay infrared (IR) commands to the mode controller. The Characteristic mode controller contains a microphone 4, amplification and filtering circuitry 5, and three radio frequency (RF) transmitter 2. It also has an (IR) receiver and transmitter as so the base unit collectively called the (IR) repeater, transceiver, Satellites antenna capabilities.

Also shown in FIG. 1 the Characteristic mode controller is generally comprised of a directional signal pickup engagement 1, a mode controller unit portion 2, a microphone 4, which are supported by the swivel supporter 3, which balance the entire body 5, respectively. The mode controller LED unit portion 2 also incorporates a speaker, Satellites antenna therein (not shown) and the swivel supporter 3.

FIG. 2 is provided with (RF) receiving portion 6, train button 7, program button 8, base (stand) 9, charger in the central middle of the base unit armpit portion 12, body 10-11, covered with circuitry such as the speech recognition unit, (IR) receiver/transmitter pair, noise cancellation circuitry, signal generator, mode controller, amplifier circuit, and filter cap, transceiver respectively, a preferred embodiment are pervious only to infrared (IR) signals the (RF) receiving portion 6 inturn includes a light receiving surfaces on the back of the Characteristic mode controller unit portion 2 middle of body 5 and above the microphone 4, which is directed toward the base unit in any direction the user positions it. The LED positioning is set so as to receive a transmitted light signal supplied from any direction and is capable of transmitting that signal back out to the base unit, the base unit retrieve signals in return through the (RF) receiving portion 6, mode controller unit portion 2, respectively. The second unit is the base unit connected to the DC outlet (not shown) in the room. The said unit must conveniently be placed in a place that can respond to characteristic mode controller. Said units contains a noise cancellation circuitry, signal generator, (RF) receiver, a speech recognition unit, Satellites antenna, transceivers, and an (IR) receiver/transmitter pair in both the base and mode controller. The base unit has power management change of condition control of communication equipment system because the circuitry in it requires significantly changing of the basic operating features described herein. There are no limitations to the five modes, known as convenience modes that optimize the convenience for the user by reducing the extent to button, key, or LCD press for which might allow utilization of entertainment devices and/or the entertainment equipment.

The mentioned five convenience modes are known as (automatically) auto mute mode, auto pause mode, auto volume mode, auto caller ID view, auto time display mode with no limitation to the number of convenience modes to be used. All convenience modes are controlled by the Characteristic mode controller, and stand alone base unit. In auto pause, auto volume, auto mute modes the user of communication entertainment equipment is automatically and dynamically allowed utilization of wireless or wired entertainment equipments or embedded communication entertainment equipment are with no limitation but at least one DVR, DVD, VCR, SAT, PVR and the likes to be provided as an alternative to wired entertainment equipment. A Satellites server will transmit the requested alternative wireless entertainment material to the base unit and Characteristic mode controller by way of Satellites server computer system and may emulate a wireless EPABX—electronic private automatic branch exchange. Auto caller ID view allows the utilization of the visitor view of the user entry door or cordless communication. The user may use a secondary control means to program the Characteristic mode controller to be active by user biometric mechanism. Avatar Characteristic voice commanding of one of the above modes causes Characteristic mode controller to activate the corresponding convenience mode and to respond to changing conditions accordingly upon the television screen display wirelessly with no button, key or LCD touch screen contact. The communication is contactless.

The Characteristic mode controller unit is constructed as described above enables reception of the transmitted light signal even when the user biometric position it in any direction, said unit receive the transmitted signal. The Characteristic mode controller utilizes a secondary battery for supplying the drive power as described above. The secondary battery is held within the Characteristic mode controller of FIG. 1, a rechargeable battery terminal portion is provided at the central middle of the mode unit portion engagement when engaged with base unit terminal 12 of FIG. 2 the said unit is set to recharge the secondary battery. Also Characteristic mode controller will have “Accessories” which can be embedded internally into the communication entertainment equipment and will work as a stand alone system. Accessories not limited to can be a video game console, view cam, and shoe cam, portable game cube, etc.

More specifically, disposed electronic circuits 10-11, which may include an amplifying circuit are incorporated in the filter cap (not shown). Filter caps are bypass circuits that are gatekeeper sensors to unapproved, unassigned, unwanted material or sound. A circuit board is located within the body of base unit 10 of FIG. 2. On the lower side surface of the circuit board 10-11 (not shown) are charging terminals 12, which are adapted to function as input terminals for secondary battery. Holes are formed in the under wall of the Characteristic mode controller unit portion 2 of FIG. 1 at the central portion and are positioned to be in line with terminal 12, respectively.

More specifically, the convenience modes may include at least but no limited to all the function controls of a traditional remote control without the buttons, LCD screen, LCD touch screen with icons. While the controlled device itself only has a handful of essential primary controls. Most all of these remotes communicate to their respective devices via infrared (IR) signals and a few via radio signals. The codes for Characteristic Voice Dependent Recognition Wireless Universal Remote Control Capabilities are stored in the base unit, transmitted to the Characteristic mode controller on screen characteristic display.

FIG. 1 furthermore illustrates preferred two unit arrangement a universal remote control unit and entertainment control unit where entertainment control unit having several embedded entertainment systems, including a DVD, SAT, VCR, Stereo theatre dual system, DVR, Cable box, Telephone line, PVR, Surround Sound dual system. A two unit arrangement may comprise of a universal remote control unit and an entertainment control unit. In the entertainment control unit a user may have the utilization of DVD, DVR, Cable Box, VCR, SAT, PVR information display upon the Characteristic mode controller via a Satellites server, the base unit and may emulate a wireless EPABX—electronic private automatic branch exchange. Usually a user of the entertainment system may have multiple of remotes and WIRED set top box units that have been presupplied with the various entertainment systems. The Characteristic Voice Dependent Recognition Wireless Universal Remote Control Capabilities base unit will allow embedded wireless utilization capability of DVD, DVR, PVR, Cable Box, VCR, SAT via Satellites server wireless communication from a standalone Satellites server mailbox and may emulate a wireless EPABX—electronic private automatic branch exchange. Further, also base unit may have an embedded internal Satellites antenna for utilization of entertainment equipment with internal control of convenience modes of said communication entertainment equipment known as “Accessories”. In particular, the preferred embodiment follows the two unit format mentioned above and includes a base unit wirelessly positioned near the external communication entertainment equipment.

The Characteristic Voice Dependent Recognition Wireless Universal Remote Control Capabilities has the capability to be at least but not limited to being automatically programmed to keep track of scheduled events, such as television shows or sporting/program event starting times, electronic automated program guide, programmed automated channel change, programmed automated volume adjustments, programmed automated caller ID view, programmed automated operational commands displayed on screen. To further elaborate on automated caller ID view, the view of visitor is visually seen on the television display unit. Visitant view can range from door monitoring, stand alone long range Satellites cordless home phone, viewmail of missed visitant messages, and the like. The Characteristic Voice Dependent Recognition Wireless Universal Remote Control Capabilities has a wireless Satellites connection to receive digital data streams with no limitation to at least for example, a typical set-top box commonly used by HDTV, satellite or cable television companies or any consumer electronic device such as a PVR, a VCR, DVD, home theater dual system components, stereo surround dual system components, or a digital video recorder (DVR). Besides the power management of universal remote control units a wireless connection to a Satellites cordless telephone has no limitation and is here referred to but not limited to as functionality Alternative to the base unit capabilities. Base unit may emulate a wireless EPABX—electronic private automatic branch exchange.

The base unit is preferably positioned to intercept electronic signals output by transceiver of Characteristic mode controller. Basic operation of mode controller and base unit is illustrated as microphone circuitry, a Satellites antenna, base unit, voice dependent program, for entering programs set and record program functionality, (mode command) an (IR) repeater, and three LED units. The (IR) repeater receives voice recognition entries, which are transmitted via infrared to the base unit, and echoes infrared commands intended for the communication entertainment equipment, which are generally at the base unit preferred embodiment. FIG. 2 basic layout of base unit train button 7, program button 8, base unit supporter 9, an internal antenna, a (RF) demodulator, a filtration module, a speech recognition module, an (IR) transceiver. The filtration module receives a continuous radio transmission from the mode controller microphone which can be referred to as USER number one, and it also receives a number of speaker inputs, each is put through an analog and digital conversion (A/D) and transformed by the application of the speaker specific transfer function. The audio mimic signal speaker inturn, is subtracted from information representing sound received at the microphone to there by generate a tenant. A tenant (residual) is spoken commands stored in the base unit memory. Because the audio mimic signal represents TV and stereo sound at the summing junction, the tenant will represent primarily speech of the mode controller also referred to as the USER number one. Tenants are programmed into the base unit by way of interactive on screen input of the secondary user during initial programming setup. The tenant is input to the speech recognition module which processes the residual to detect user speech, to learn new user spoken command, and to associate a detection of a known spoken command with an (IR) command intended for one or more of the communication entertainment equipment, these commands are stored in an (IR) code selection table for selective transmission using the (IR) transceiver. Significantly, the mode controller and the base unit, do not process all generated audio, user motion detection and Characteristic mode controller on screen display is important also. The microphone removes high and low audio frequencies sent via (RF) to the base unit and mode controller unit. The preferred embodiment is designed to accept speaker inputs from a 5.1 channel system.

Further, when the signal is received concerning an incoming event from the Characteristic Voice Dependent Recognition Wireless Universal Remote Control Capabilities base unit, the signal may be transmitted to the microprocessor. The microprocessor may, in turn, retrieve informational instructions from the data storage area, interpret the signal using the instructions, and provide an automated wireless alert to USER number two that a scheduled event is about to occur or that there is an incoming cordless visitor communication or by activating the speaker on the display source. The Characteristic mode controller functionality provides an overlay placed over a display device and can be any of a variety of different display devices, such as a cathode ray tube (CRT) television, plasma/flat panel television, and liquid crystal display (LCD), projector, and so forth. An interactive Characteristic overlay is displayed on the full-screen display. Both program content and media Characteristic mode controller content are displayed on a full-screen display such as a television. An interactive Characteristic overlay is of voice dependent and can be displayed independent of any user request for the overlay to be displayed automatically upon set program during which reception of the direction mode indicator indicates that the mode controller selection command is made for a device. Additionally, a notification icon can be displayed during display of the program content and/or the media content or caller ID view. The notification icon can be selected by secondary USER number two by biometric mechanism, or by automatic preprogramming Characteristic mode controller which is also referred to as a USER number one to respond, and in response to such a selection the interactive Characteristic overlay is displayed and command carried out. The Characteristic mode controller can be fully customized to represent different scheduled events or incoming cordless visitor communication which is a functionality with no limitation.

The preferred embodiment must be configured to learn spoken commands, to learn (IR) commands that are to be associated with each spoken command, learn Interactive on screen configuration may be achieved by biometric mechanisms. Speech recognition triggers by the Characteristic mode controller allows the base unit to enter into configuration and learning modes. The purpose of the command learning mode is to enable the base unit to detect spoken commands and associate them with infrared (IR) code commands for sending to the carious Characteristic mode controller power management on screen Characteristic display. The mode controller and base unit automatically enters into these modes for initial configuration. No button press, LCD screen press, LCD touch screen icons press or key press is needed. Another aspect is the Characteristic mode controller on screen display is referred to as a USER number one and may operate as a stand alone power management change of condition control unit between the base unit and communication entertainment equipment, mode controller can automatically be programmed to operate as user programs. Both units may emulate a wireless EPABX—electronic private automatic branch exchange.

Operation

Design of Mode Controller Unit

The design of a preferred Characteristic mode controller unit portion 2 is presented using FIG. 1 the base unit is secondary to mode controller and somewhat similar in appearance and size. Characteristic mode controller is USER number one and the secondary client is USER number two. The preferred Characteristic mode controller unit also includes a microphone, a power circuitry (not shown), three LED units, and mini circuit board for voice recognition. Because the Characteristic mode controller unit normally functions to transmit sound detected by the microphone by the on screen Characteristic to the base unit back to the Characteristic mode controller, it is desirable to power down when not in use to conserve power. The Characteristic mode controller is automated and is the key, button, LCD press to traditional universal remote controls. The (IR) transmission window faces toward the base unit, the design of the Characteristic mode controller unit positions the microphone and the microphone arm inclined toward the open room area. The Characteristic mode controller unit uses a battery to generate a direct current (DC) power supply and is used to drive the microphone circuitry, (IR) repeater, and speech recognition circuitry. The microphone circuitry includes a microphone, a band pass filter which removes low and high frequency components the output is then provided to an (RF) modulator which transmit audio which has been received at the microphone through an internal antenna to the base unit. The (IR) repeater circuitry uses both an infrared detector and an infrared transmitter each having a buffer and driver circuitry. The (IR) detector includes a buffer which demodulates infrared into a digital code, which is then transferred using a micro controller to the buffer and driver for the (IR) transmitter. The (IR) circuitry will affectively repeat received (IR) commands to reflect them back towards a base unit enable the micro controller chip which also includes a buffer electronics, which controls code command to the base unit using a device code which is hard wired into the mode controller unit. Furthermore, the mode controller will contain speech recognition system as well as the base unit for better control and wider (IR) and (RF) range pick up.

The present invention directional motion detection indicator is selected by secondary USER number two by biometric mechanism, or by automatic preprogramming mode controller to respond, and in response to such a selection the interactive Characteristic overlay is displayed. Directional motion detection indicator may consist of a long range perspective angle motion sensor corresponding to the different orientation directions of the Characteristic mode controller.

According to another embodiment of the present invention, the long range perspective angle indicator of the motion detection corresponding to the different orientation directions of the Characteristic mode controller, may detect the motion as a response to a command or request selection by secondary USER number two.

According to another embodiment, the directional motion detection indicator is not limited to biometric mechanism. Any means that adequately relays the response to a command or submit a request to the Characteristic mode controller when not in preprogram mode of operation information of, for example, a television, any consumer electronic device such as a PVR, a VCR, DVD, home theater dual system components, stereo surround dual system components, or a digital video recorder (DVR). The Characteristic Voice Dependent Recognition Wireless Universal Remote Control Capabilities base unit will allow embedded utilization of DVD, DVR, PVR, VCR, SAT, and the likes via Satellites wireless communication from a standalone Satellites server mailbox computer system and may emulate a wireless EPABX—electronic private automatic branch exchange, the secondary USER number two will become primary command source. Besides the power management of universal remote control units a wireless connection to a Satellites cordless visitor ID view has no limitation and is hereby referred to but not limited to as functionality to the base unit capabilities and is a convenience mode. Further, The motion detector detects the command request of the secondary USER number two and sends a signal to the base unit microprocessor indicating the response to a command by secondary USER number two thereof. After receiving the response, the base unit microprocessor, acting on informational instructions retrieved, changes the mode of operation and transmits the command to the mode controller. The Characteristic mode controller then carries out the command to the appropriate consumer electronic device may be, for example, a wired PVR, a VCR, DVD, home theater dual system components, stereo surround dual system components, or a digital video recorder (DVR)

Design of Base Unit

The wireless stand alone base unit is a rectangular shape, having an AC cord for plug in to an outlet, speaker signals, and (IR)(RF) transmission window for communication with the Characteristic mode controller on screen display and for learning (IR) commands by way of voice recognition and biometric motion from the secondary USER number two. The base unit receives power via a plug from an electrical outlet, which is then input to a power supply to generate a supply voltage. The base unit also includes a backup battery which helps enable memory retention in the event of a power failure for such things as learned spoken and (IR) commands and (RAM) and (ROM) memory of stored transmission. The base unit further includes a set of wireless CMOS/CCD modules to position for auto visitant ID view. Further, a base unit may have accessories that can be embedded internally in a communication entertainment equipment as a mode controller, further base unit may emulate a wireless EPABX—electronic private automatic branch exchange. The Satellites antenna is coupled to an (RF) demodulator, an amplifier, a band pass filter and an analog to digital (A/D) converter for production of a digital signal. The signal represents an electronic speaker sound and spoken command received within the 200 hertz to 4,000 hertz range via the base unit. The digital signal is then input to a subtraction circuit which filters the digital signal by subtraction from it the radio mimic signal to reproduce a residual.

Speech recognition is performed using the tenant (residual) by first determining whether the residual possibly represent speech and, if so, by comparing the residual between biometric motion of USER number two incoming commands and request and Characteristic mode controller USER number one on screen display stand alone preprogrammed spoken command, the control microprocessor is pointed to another address in RAM that stores digital information for each (IR)(RF) command to be transmitted, embedded wireless emulation of a PVR, a VCR, DVD, home theater dual system components, stereo surround dual system components, or a digital video recorder (DVR) and the likes are part of the base unit and may emulate a wireless EPABX—electronic private automatic branch exchange. Further, base unit including device codes and these are written by the microprocessor into buffer and driver circuitry for an (IR) (RF). This buffer and driver circuitry is effective to transmit (IR)(RF) codes once loaded the transmission is preferably governed by hardware. Similarly, when an (IR)(RF) command is received at an (IR)(RF) receiver from the Characteristic mode controller unit. If the incoming (IR)(RF) command reflects a Characteristic mode controller command then the microprocessor affects the selected command or mode as soon as practical. If the incoming command includes any other device code, the spoken command will otherwise disregard the incoming (IR)(RF) command. The base unit includes a signal generator and amplifier which are selectively activated by the control microprocessor during the speaker learning mode in order to generate test signals. However, during the speaker learning mode, the signal generator is given control over the outputs. The signal generator utilizes a read only memory (ROM) to generate appropriate test signals and drive each audio channel, inturn, as a slave to the control microprocessor.

During operation, if a spoken command is recognized from the Characteristic mode controller on screen display or secondary USER number two biometric motion, the base unit sends the associated (IR)(RF) command via its (IR)(RF) transmitter to the Characteristic mode controller on screen display, which inturn sends those commands back to the appropriate communication entertainment equipment, base unit may also emulate a wireless EPABX—electronic private automatic branch exchange. This is the task of the base unit (IR) repeater.

Learning of Spoken and Infrared Commands

Learning of speaker and room configuration is required upon initial power up when speaker parameters are not available from memory, and when the user select a speaker learning mode voice recognized on the base unit. The base unit control microprocessor is master over the operation and performs two tests for each audio channel one channel at a time, during this calibration there should be complete silence besides the test signals. See John G. Proakis, Masaed Sahehi, “Communication System Engineering”, Prentice Hall, Englewood Cliffs, N.J. 07632 ISBN 0-13-158932-6 and See Edward A Lee, David G. Messer Schimitt, “Digital Communication” Flower Academic Publishers, Boston 1994, ISBN 0-7923-9391-0.

Learning Spoken Command

During command learning, there must be complete silence in the room besides the spoken commands. There are many different speech processing devices and algorithms which are commercially available. Selection of a suitable speech processing device or algorithm is left to one skilled in electronics. It is expected that the preferred device will use a vocabulary which is on the order of a hundred words and phrases for the base unit and Characteristic mode controller on screen display to recognized the speech, therefore the embodiment uses stochastic speech processing system that processes phonemes and proceeding from one phoneme to the next, matches detected phonemes against a table of stored codes and determine whether a spoken command represent a stored code. Preprogrammed words, phrases, and statements will be embedded in the micorprocessor of the base unit. The secondary USER number two biometric mechanism motion detection indicator or the Characteristic mode controller USER number one voice command can automatically command the learn mode to enter the command learning mode and sends an (IR) signal using the base units device code, such that it is detected by the control microprocessor. The secondary USER number two is prompted during initial programming to motion the appropriate set up programming commands by following the prompts on the display device screen. After the initial set up programming proceeding through the process for learning a command for the Characteristic mode controller on screen display. The secondary USER number two may combine commands for a number of devices. Between this time the Characteristic mode controller on screen display, the control microprocessor will associate any received (IR)(RF) command and records them to automatically control communication entertainment equipment without USER number two input. The base unit receives the (IR)(RF) communication via its wireless transceiver and stores the corresponding bit information stream in the local RAM for the control microprocessor.

Base unit speech recognition module first monitors the tenant to determine whether the residual represents a possible secondary USER number two biometric motion command or a Characteristic mode controller USER number one on screen display spoken command and if so, then proceeds to map the detected signal against a data base representing the learning code commands because speech may dcor at different rates, each spoken command of first or motion command of secondary is preferably represented as a sequence of speech Characteristics and matching of the detected signal against a known code command. During the learning process, the user repeats a prompted motion commands to be learned a number of times in order to establish a data base which is then used in aid probability analysis the learned pattern is stored along with the associated (IR)(RF) bit string in the local RAM of the central microprocessor. The number of different users will be fairly limited in most cases and a separate vocabulary for each user can easily be maintained.

Microphone

Embodiment uses multiple microphones within the mode controller and base unit all separated from each other by a suitable distance.

### SUMMARY, RAMIFICATIONS, AND SCOPE

In summary, the present invention relates to a Characteristic Voice Dependent Recognition Wireless Universal Remote Control Capabilities with a programmable Characteristic mode controller on screen display that give power management to automatically allow utilization of communication entertainment equipment and Universal remote control to reduce interference and/or interruptions. Base unit may emulate a wireless EPABX—electronic private automatic branch exchange, may function to emulate DVD, PVR, VCR, home theatre dual system and the like. The secondary USER number two may select from at least but not limited to five convenience modes, including those which automatically facilitate utilization of communication entertainment equipment and those which automatically prevent communication entertainment equipment from interrupting or interfering with utilization and administer change of control conditions between communication equipment and universal remote control equipment by way of Characteristic mode controller, also an embedded internal communication entertainment equipment mode controller may function to emulate DVD, PVR, VCR, home theatre dual system and the like. Technology other than infrared might be utilized to transmit remote control signals to the entertainment devices. Likewise, technology other than voice recognition could be utilized to obtain user input. Although, recharging is accomplished in the illustrative and power maintained, instead, through use of spare batteries that are recharged out side of the mode controller and used to replace a discharged battery as needed. In addition, numerous other changes could also be made.

Having described several implementations of the invention, it will be apparent that various alterations modifications and improvements will be readily occur to those skilled in the art of product engineering. Such alterations, modifications and improvements, throughout describe above, are none the less intended and implied to be within the spirit and scope of the invention.

The foregoing discussion is intended to be illustrative only. The principles of the invention, as defined by the claims appended herein, can obviously be applied beyond the specifically described embodiments of the invention described herein. Moreover, in the description of the present invention, certain details have been left out in order to not obscure the inventive aspects of the invention. The details left out are within the knowledge of a person of ordinary skill in the art.

1-2. (canceled)

3. Universal remote control equipment provides for remote control of one or more entertainment devices.

4-11. (canceled)

12. A Characteristic Voice Dependent Recognition Wireless Universal Remote Control Capabilities comprising; a Characteristic mode controller having a power management that include administering change of control conditions between communication entertainment equipment and universal remote control equipment by way of Characteristic mode controller on screen display (OSD) upon a display device as an interactive overlay. The display device can be a variety of different display devices, such as a cathode ray tube (CRT) television, plasma/flat panel television, liquid crystal display (LCD), projector, and so forth. Further, the Characteristic mode controller provides but not limited to at least one convenience mode.

13. A Characteristic Voice Dependent Recognition Wireless Universal Remote Control Capabilities according to claim 1 wherein, an interactive Characteristic overlay is displayed, and this interactive Characteristic mode controller overlay is of voice dependent and can be displayed independent of any user request for the overlay to be displayed or automatically upon set up programming, during which reception of the command indicator indicates that a selection command is made for a device with the assistance of motion sensors.

14. Universal remote control equipment provides for remote control of one or more entertainment devices

15. A Characteristic Voice Dependent Recognition Wireless Universal Remote Control Capabilities according to claim 1 wherein, a power management is of Characteristic mode controller which is a bridge to the base unit and has no keys, buttons, and LCD screen.

16. A device as cited in claim 1, control capabilities includes a two unit arrangement a universal remote control unit and entertainment control unit having several wireless entertainment systems, embedded entertainment system internally wherein Characteristic mode controller power management provides functionality and information display on screen via the base unit wirelessly from the standalone Satellites server mailbox and may emulate a wireless EPABX—electronic private automatic branch exchange.

17. A device as cited in claim 2, wherein, both program content and media Characteristic mode controller content are displayed on a full-screen display such as a television and utilize directional motion detection indicator is biometric mechanism, or automatic preprogramming mode controller to respond. Directional motion detection indicator may consist of a long range perspective angle motion sensor corresponding to the different orientation directions of the Characteristic mode controller.
